(19) United States
(12) Patent Application Publication
(10) Pub. No.: US 2011/0206265 A1
(43) Pub. Date: Aug. 25, 2011

(54) PAPER SHEET MANAGEMENT DEVICE, PAPER SHEET MANAGEMENT METHOD, AND PAPER SHEET MANAGEMENT PROGRAM

(76) Inventors: Toshio Numata, kanagawa-ken (JP); Gui Fu, Tokyo-To (JP); Hajime Morino, Saitama-ken (JP)

(21) Appl. No.: 12/998,140

(22) PCT Filed: Sep. 22, 2008
(86) PCT No.: PCT/JP2008/067133

§ 371 Date: Apr. 28, 2011

(51) Int. Cl. G06K 9/00

(52) U.S. Cl. 382/135

(57) ABSTRACT

A paper sheet management apparatus includes a serial number recognition unit (37A) recognizing the serial numbers of all transaction banknotes, for each banknote transaction, a banknote transaction list information preparation unit (37F) preparing banknote transaction list information on the serial numbers of all transaction banknotes recognized by the serial number recognition unit (37A), and a print and output control unit (37G) printing and outputting a banknote transaction list, based on the banknote transaction list information prepared by the banknote transaction list information preparation unit (37F). With this configuration, the teller can present the banknote transaction list to the customer, and thus the teller and customer can respectively confirm the transaction content, based on the banknote transaction list, and clarify the source of each transaction banknote, i.e. the transaction content of each banknote, thereby to ensure the reliability of the transaction, as well as to achieve a stable banknote transaction.

### FIELD OF THE INVENTION

The present invention relates to a paper sheet management apparatus, a paper sheet management method and a paper sheet management program, respectively adapted for recognizing recognition information on each paper sheet, for each predetermined transaction, and preparing a recognition information list related to the recognized recognition information on each paper sheet, for each predetermined transaction, and then outputting the so-prepared recognition information list.

### BACKGROUND ART

As an apparatus for counting the number of paper sheets, such as banknotes, checks, bills, gift coupons and so on, while sorting the paper sheets depending on sorting conditions such as types or the like, a paper sheet handling apparatus has been conventionally known (see, e.g., Patent Document 1).

The paper sheet handling apparatus has a plurality of stacking units, i.e. stackers for staking paper sheets, for each preset sorting condition. The paper sheet handling apparatus is configured to sort and stack paper sheets depending on the sorting conditions, and to count the number of paper sheets stacked in the respective stackers.

Namely, when paper sheets to be handled are Japanese banknotes, for example, the paper sheet handling apparatus has a first stacker for 10,000-yen banknote, a second stacker for 5,000-yen banknote, a third stacker for 2,000-yen banknote and a fourth stacker for 1,000-yen banknote. In this case, even when Japanese banknotes of plurality of denominations are put into the paper sheet handling apparatus, the banknotes are sorted such that a 10,000-yen banknote is stacked in the first stacker, a 5,000-yen banknote is stacked in the second stacker, a 2,000-yen banknote is stacked in the third stacker, and a 1,000-yen banknote is stacked in the fourth stacker.

In recent years, there has been known a paper sheet management system including a paper sheet handling apparatus and a paper sheet management apparatus, such as a personal computer, connected to the paper sheet handling apparatus so as to manage the paper sheet handling apparatus (see, Patent Documents 2, 3 and 4, for example).

The paper sheet management apparatus is configured to store, in a database, banknote detail information of respective banknotes having been put into the paper sheet handling apparatus, such as a denomination result for recognizing denominations of the banknotes, a fitness result for recognizing fit notes and unfit notes, and transaction data, in a manner where each banknote detail information is related to each other. The transaction data include, for example, a transaction start date and time of banknotes put into the paper sheet handling apparatus, and a user ID for recognizing a person who has deposited or dispensed the banknotes.

Further, in the case of the so-called automatic (or automated) teller machine (hereinafter, referred to as the “ATM”), when a depositing transaction is carried out, an image of the serial number of each deposited banknote is taken or obtained, and then the so-taken image of the serial number of the deposited banknote and a related customer ID are respectively registered and managed. Thereafter, if the deposited banknote is determined later to be a counterfeit note, the customer ID related to the serial number of this deposited banknote can be searched, thereby to identify the person that made the transaction of this deposited banknote, based on the result of this search (e.g., see Patent Documents 5 and 6).
Patent Document 1: JP2008-46870A
Patent Document 2: JP2004-310594A
Patent Document 3: U.S. Pat. No. 7,201,320
Patent Document 4: U.S. Pat. No. 7,040,476
Patent Document 5: JP11-328475A
Patent Document 6: JP7-121753A

### SUMMARY OF THE INVENTION

In recent years, the counterfeit notes have been circulated in many countries, and there are many cases in which such counterfeit notes are deposited, even in a usual financial institution, branch or the like.

To address this problem, in a conventional banknote management apparatus, when the depositing transaction, for the banknote (or banknotes), to a certain financial institution from a certain customer, is carried out, the image of the serial number of each deposited banknote is taken, and then the so-taken image of the serial number of the deposited banknote and the customer ID are respectively registered. Thereafter, if the deposited banknote is determined later to be the counterfeit note, the customer ID corresponding to the serial number of this deposited banknote is searched, thereby to identify the person that made the transaction of this deposited banknote, based on the customer ID. However, it is quite difficult to make the so-identified person himself (or herself) recognize that the person has actually carried in or deposited such a counterfeit note.

Further, in some countries, there have been rare cases in which the counterfeit notes have been mistakenly dispensed to a certain customer, upon a dispensing transaction to the customer from a certain financial institution. The cases cause some great distrust of the customer to such a financial institution.

Namely, in either case of the depositing and dispensing transactions of the banknotes, there is now a strong demand for ensuring the reliability upon the banknote transaction, between the financial institution and the customer, i.e., between the persons respectively related to the banknote transaction. Of course, not only upon the banknote transaction, such reliability is now strongly demanded, also upon the general transaction of the paper sheets including the checks, bills or drafts, vouchers and the like.

The present invention has been made in view of the above circumstances. The object of this invention is to provide the paper sheet management apparatus, paper sheet management method and paper sheet management program, respectively adapted for allowing each person related to the transaction of the paper sheets to clarify the source of each transaction paper sheet, i.e., the transaction content of each paper sheet, thereby to ensure the reliability between the persons respectively related to the transaction of the paper sheets, thus achieving a significantly stable transaction of the paper sheets.

### MEANS FOR SOLVING THE PROBLEM

In order to achieve the above object, the paper sheet management apparatus, which is set forth in claim 1 in the appended claims of the present application, includes: a recognition information identifying unit configured to identify the recognition information on each paper sheet, for each predetermined transaction; a recognition information list preparation unit configured to prepare the recognition information list related to the recognition information identified by the recognition information identifying unit, for each predetermined transaction; and a recognition information list output unit configured to output the recognition information list prepared by the recognition information list preparation unit.

Further, in the paper sheet management apparatus, which is set forth in claim 2 and according to claim 1 in the appended claims of this application, the recognition information list output unit is provided as a print and output unit configured to print and output the recognition information list prepared by the recognition information list preparation unit.

Further, in the paper sheet management apparatus, which is set forth in claim 3 and according to claim 2 in the appended claims of this application, the recognition information list includes a verification column provided for requesting verification of the transaction content related to the recognition information list.

Further, in the paper sheet management apparatus, which is set forth in claim 4 and according to claim 1 in the appended claims of this application, the recognition information list output unit is provided as a display and output unit configured to display and output the recognition information list prepared by the recognition information list preparation unit.

Additionally, the paper sheet management apparatus, which is set forth in claim 5 and according to claim 4 in the appended claims of this application, further includes a verification request unit configured to request the verification of the transaction content related to the recognition information, for each of the recognition information in the recognition information list, upon the display and output of the recognition information list by the display and output unit.

In addition, the paper sheet management apparatus, which is set forth in claim 6 and according to claim 4 in the appended claims of this application, further includes a verification request unit configured to request collective verification of the transaction content related to the recognition information list, for each predetermined transaction, upon the display and output of the recognition information list by the display and output unit.

Additionally, the paper sheet management apparatus, which is set forth in claim 7 and according to claim 4 in the appended claims of this application, further includes a verification request unit configured to request the verification of the transaction content related to any given recognition information among the recognition information on a plurality of paper sheets in the predetermined transaction, as the collective verification of the transaction content related to the recognition information list, upon the display and output of the recognition information list by the display and output unit.

Further, in the paper sheet management apparatus, which is set forth in any one of claims 8 to 10 and according to any one of claims 5 to 7 in the appended claims of this application, the verification of the transaction content is performed in response to an operation of a verification button.

Additionally, the paper sheet management apparatus, which is set forth in claim 11 and according to claim 1 in the appended claims of this application, further includes a user verification unit configured to verify a user by using a recording medium containing data for verification, when the recording medium is detected upon starting the predetermined transaction, wherein the recognition information list output unit is provided as a registration and output unit configured to register and output the recognition information list prepared by the recognition information list preparation unit to the recording medium.

Further, in order to attain the above object, the paper sheet management method, which is set forth in claim 12 in the appended claims of the present application, includes: identifying the recognition information on each paper sheet for each predetermined transaction; preparing the recognition information list related to the recognition information which is identified for each predetermined transaction in the identification of the recognition information; and outputting the recognition information list prepared in the preparation of the recognition information list.

Further, in order to achieve the above object, the paper sheet management program, which is set forth in claim 13 in the appended claims of the present application and is executed by a computer, includes: a recognition information identifying process for identifying the recognition information on each paper sheet, for each predetermined transaction; a recognition information list preparation process for preparing the recognition information list related to the recognition information identified in the recognition information identifying process, for each predetermined transaction; and a recognition information list output process for outputting the recognition information list prepared in the recognition information list preparation process.

According to the paper sheet management apparatus configured as set forth in claim 1 of the appended claims of this application, the recognition information on each paper sheet is recognized for each predetermined transaction, the recognition information list related to the recognized recognition information on each paper sheet is prepared for each predetermined transaction, and then the so-prepared recognition information list is outputted, for instance, the recognition information list is presented to the person that makes the transaction on the paper sheets. In this way, the person that makes the transaction on the paper sheets can confirm the transaction content based on the presented recognition information list. Thereby, the source of each paper sheet, i.e. the transaction content of each paper sheet, is clarified to ensure the reliability of the transaction. As a result, the significantly stable paper sheet transaction can be achieved.

Further, according to the paper sheet management apparatus as set forth in claim 2 of the appended claims of this application, the recognition information list output unit is provided as the print and output unit configured to print and output the recognition information list. Therefore, in addition to the effect that can be obtained by the paper sheet management apparatus as set forth in claim 1, the person that makes the transaction on the paper sheets can confirm the transaction content based on the printed recognition information list. Thereby, the source of each transaction paper sheet, i.e. the transaction content of each paper sheet, is clarified to ensure the reliability of the transaction. As a result, the significantly stable paper sheet transaction can be achieved.

Further, according to the paper sheet management apparatus as set forth in claim 3 of the appended claims of this application, the recognition information list includes the verification column provided for requesting the verification of the transaction content related to the recognition information list. Therefore, in addition to the effect that can be obtained by the paper sheet management apparatus as set forth in claim 2, the person that makes the transaction on the paper sheets can clarify indication of the intention to verify or not to verify the transaction content based on the presence or absence of the verification of the transaction content in the verification column.

Further, according to the paper sheet management apparatus as set forth in claim 4 of the appended claims of this application, the recognition information list output unit is provided as the display and output unit configured to display and output the recognition information list. Therefore, in addition to the effect that can be obtained by the paper sheet management apparatus as set forth in claim 1, the person that makes the transaction on the paper sheets can confirm the transaction content based on the displayed recognition information list. Therefore, the source of each transaction paper sheet, i.e. the transaction content of each paper sheet, is clarified to ensure the reliability of the transaction. As a result, the significantly stable paper sheet transaction can be achieved.

Further, according to the paper sheet management apparatus as set forth in claim 5 of the appended claims of this application, the verification of the transaction content related to the recognition information can be requested for each of the recognition information in the recognition information list, upon the display and output of the recognition information list. Therefore, in addition to the effect that can be obtained by the paper sheet management apparatus as set forth in claim 4, the person that makes the transaction on the paper sheets can request the verification of the transaction content for each paper sheet, thereby to clarify the indication of the intention concerning the transaction content for each paper sheet.

Further, according to the paper sheet management apparatus as set forth in claim 6 of the appended claims of this application, the collective verification of the transaction content related to the recognition information list can be requested for each predetermined transaction, upon the display and output of the recognition information list. Therefore, in addition to the effect that can be obtained by the paper sheet management apparatus as set forth in claim 4, the person that makes the transaction on the paper sheets can request the verification of the transaction content for each transaction, thereby to clarify the indication of the intention concerning the transaction content for each transaction as well as to significantly reduce the burden required for the verification.

Further, according to the paper sheet management apparatus as set forth in claim 7 of the appended claims of this application, the verification of the transaction content related to any given recognition information among the recognition information on the plurality of paper sheets in the predetermined transaction can be requested as the collective verification of the transaction content related to the recognition information list, upon the display and output of the recognition information list. Therefore, in addition to the effect that can be obtained by the paper sheet management apparatus as set forth in claim 4, the person that makes the transaction on the paper sheets can request the verification of the transaction content related to any given recognition information among the recognition information on the plurality of paper sheets in the predetermined transaction, thereby to clarify the indication of the intention concerning the transaction content as well as to significantly reduce the burden imposed on the verification.

Further, according to the paper sheet management apparatus as set forth in any one of claims 8 to 10 of the appended claims of this application, the verification of the transaction content is performed, in response to the operation of the verification button. Therefore, in addition to the effect that can be obtained by the paper sheet management apparatus as set forth in any one of claims 5 to 7, the person that makes the transaction on the paper sheets can verify the transaction content due to the operation of the verification button.

Further, according to the paper sheet management apparatus as set forth in claim 11 of the appended claims of this application, the recognition information list can be registered and outputted to the recording medium used for the user verification. Therefore, in addition to the effect that can be obtained by the paper sheet management apparatus as set forth in claim 1, the person that makes the transaction on the paper sheets can readily clarify the source of each transaction paper sheet, i.e. the transaction content of each paper sheet, based on the recognition information list registered in the recording medium without performing any special operation for the verification, thereby to ensure the reliability of the transaction. As a result, the significantly stable paper sheet transaction can be achieved.

Further, according to the paper sheet management method as set forth in claim 12 of the appended claims of this application, the recognition information on each paper sheet is recognized for each predetermined transaction, the recognition information list related to the so-recognized recognition information on each paper sheet is prepared for each predetermined transaction, and then the so-prepared recognition information list is outputted, for instance, the recognition information list is presented to the person that makes the transaction on the paper sheets. Thus, the person that makes the transaction on the paper sheets can confirm the transaction content based on the recognition information list. Thereby, the source of each transaction paper sheet, i.e. the transaction content of each paper sheet, is clarified to ensure the reliability of the transaction. As a result, the significantly stable paper sheet transaction can be achieved.

Further, according to the paper sheet management program as set forth in claim 13 of the appended claims of this application, the recognition information on each paper sheet is recognized for each predetermined transaction, the recognition information list related to the so-recognized recognition information on each paper sheet is prepared for each predetermined transaction, and then the so-prepared recognition information list is outputted, for instance, the recognition information list is presented to the person that makes the transaction on the paper sheets. Thus, the person that makes the transaction on the paper sheets can confirm the transaction content based on the presented recognition information list. Thereby, the source of each transaction paper sheet, i.e. the transaction content of each paper sheet, is clarified to ensure the reliability of the transaction. As a result, the significantly stable paper sheet transaction can be achieved.

### BRIEF DESCRIPTION OF THE DRAWINGS

FIG. 1 is a system explanatory view showing a schematic structure of an overall banknote management system related to a first embodiment of the present invention.

FIG. 2 is a block view showing a schematic structure inside the banknote management system.

FIG. 3 is an explanatory view briefly showing a data structure of banknote detail information.

FIG. 4 is an explanatory view briefly showing a data structure of transaction information.

FIG. 5 is an explanatory view briefly showing the content of a printed banknote transaction list.

FIG. 6 is a flow chart showing a process operation related to a banknote sorting and stacking process performed in a banknote handling apparatus.

FIG. 7 is a flow chart showing a process operation related to a banknote detail information registration process performed in the banknote management apparatus.

FIG. 8 is a flow chart showing a process operation related to a banknote transaction list print and output process performed in the banknote handling apparatus.

FIG. 9 is a block diagram schematically showing internal construction of the ATM related to a second embodiment of the present invention.

FIG. 10 is an explanatory view briefly showing a transaction serial number list presenting screen displayed on an ATM-side display unit of the ATM.

FIG. 11 is an explanatory view briefly showing a transaction serial number individual verification screen displayed on the ATM-side display unit of the ATM.

FIG. 12 is a flow chart showing a process operation related to an ATM depositing process performed in the ATM.

FIG. 13 is a flow chart showing the process operation related to the ATM depositing process performed in the ATM.

### REFERENCE NUMERALS

3: Banknote management apparatus
37A: Serial number recognition unit
37F: Banknote transaction list information preparation unit
37G: Print and output control unit
80: Banknote transaction list
82: Teller confirmation entry column
83: Customer confirmation entry column
100: ATM
112: Serial number recognition unit
116: Serial number list preparation unit
117: Serial number list output control unit
130: Transaction serial number list presenting screen
140: Transaction serial number individual verification screen

### DETAILED DESCRIPTION OF THE INVENTION

Hereinafter, the banknote management system and ATM, respectively related to one embodiment of the paper sheet management apparatus, paper sheet management method and paper sheet management program respectively according to this invention, will be described in detail with reference to the drawings.

Generally, this embodiment is intended for preparing a serial number list related to the serial number of each transaction banknote, for each banknote transaction, and then presenting and outputting the so-prepared serial number list to the person (or persons) that makes the banknote transition.

As a result, the person that makes the banknote transaction can confirm the transaction content, based on the presented and outputted serial number list. Thereby, the source of each transaction banknote, i.e. the transaction content of each banknote, is clarified to ensure the reliability of the transaction. As a result, the stable banknote transaction can be achieved.

### Embodiment 1

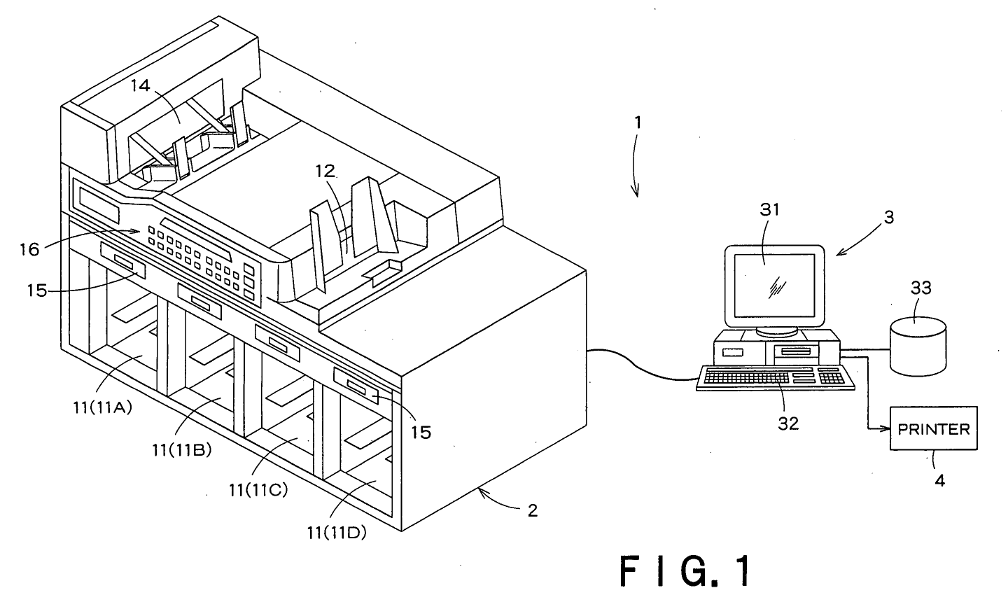

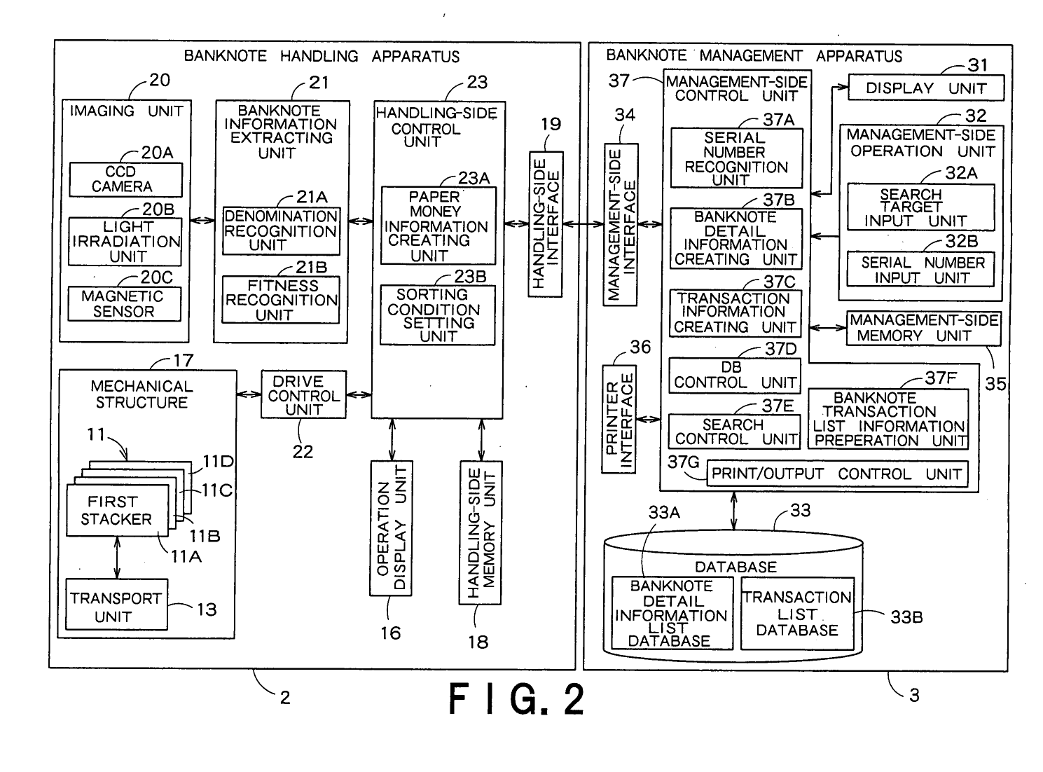

FIG. 1 is an explanatory view showing a schematic structure of an overall banknote management system related to a first embodiment of the present invention, and FIG. 2 a block view showing a schematic structure inside the banknote management system.

The banknote management system 1 shown in FIG. 1 includes a banknote handling apparatus 2 having a plurality of stackers 11 for stacking banknotes, a banknote management apparatus 3 such as a personal computer for managing the banknote handling apparatus 2, and the printer 4 having a print and output function. The banknote handling apparatus 2 is configured to sort banknotes based on sorting conditions set for the respective stackers 11, and to sequentially stack the sorted banknotes in the plurality of stackers 11 corresponding to the sorting conditions.

The banknote handling apparatus 2 includes: a banknote inlet unit 12 through which banknotes are supplied; a transport unit 13 (see, FIG. 2) configured to transport banknotes supplied from the banknote inlet unit 12 one by one; the plurality of stackers 11 configured to sequentially stack the banknotes having been transported by the transport unit 13; a reject unit 14 configured to reject a banknote that does not fall under the aforementioned sorting conditions of the stackers 11; stacker display units 15 configured to display states of the respective stackers 11; and an operation display unit 16 configured to input or display various information. The stacker display unit 15 displays state information such as the number of banknotes counted by the stacker, a batch state, and so on.

The stackers 11 include a first stacker 11A, a second stacker 11B, a third stacker 11C and a fourth stacker 11D, for the respective banknote sorting conditions. The sorting conditions can be suitably changed depending on a specifying operation from the banknote handling apparatus 2 or the banknote management apparatus 3.

When a banknote having been transported by the transport unit 13 falls under the sorting condition of the first stacker 11A, the banknote handling apparatus 2 stacks the banknote in the first stacker 11A. Similarly, when a banknote having been transported by the transport unit 13 falls under the sorting condition of the second stacker 11B, the banknote handling apparatus 2 stacks the banknote in the second stacker 11B. When a banknote having been transported by the transport unit 13 falls under the sorting condition for the third stacker 11C, the banknote handling apparatus 2 stacks the banknote in the third stacker 11C. When a banknote having been transported by the transport unit 13 falls under the sorting condition of the fourth stacker 11D, the banknote handling apparatus 2 stacks the banknote in the fourth stacker 11D.

In addition, when a banknote having been transported by the transport unit 13 does not fall under any of the sorting conditions of the first stacker 11A, the second stacker 11B, the third stacker 11C and the fourth stacker 11D, the banknote handing apparatus 2 is configured to transport the banknote to the reject unit 14.

The banknote management apparatus 3 is connected to the banknote handling apparatus 2 so as to manage the banknote handling apparatus 2. The banknote management apparatus 3 includes a display unit 31 configured to display various information, a management-side operation unit 32 configured to input various information, and a database 33 configured to register and manage banknote detail information of a banknote.

In this case, the banknote management apparatus 3 is connected with the printer 4 in order to operate this printer 4 to print and output the various information or contents.

The banknote handling apparatus 2 shown in FIG. 2 includes a mechanical machine 17 composed of stackers 11 and the transport unit 13, the operation display unit 16, a handling-side memory unit 18 configured to store various information, and a handling-side interface 19 serving as a communication interface between the banknote handling apparatus 2 and the banknote management apparatus 3.

Further, the banknote handling apparatus 2 includes a imaging unit 20 configured to image a face image and a back image of a banknote having been transported by the transport unit 13, a banknote information extracting unit 21 configured to extract banknote information from the banknote image imaged by the imaging unit 20, a drive control unit 22 configured to control the drive of the mechanical structure 17, and a handling-side control unit 23 configured to control the whole banknote handling apparatus 2.

The imaging unit 20 has a light irradiating unit 20B configured to irradiate plural kinds of light beams, such as a visible light beam, an infrared light beam, a green light beam and so on, onto a banknote having transported by the transport unit 13, and a CCD (Charge Coupled Device) camera 20A.

The imaging unit 20 is configured to sequentially irradiate plural kinds of light beams by the light irradiating unit 20B onto a banknote having transported by the transport unit 13, and to receive reflected lights reflected on the banknote by the CCD camera 20A, so as to image a face image and a back image of the banknote.

Further, the imaging unit 20 is configured to irradiate a light beam by the light irradiating unit 20B onto a banknote and receive a transmitted light beam transmitting through a front and back faces of the banknote by the CCD camera 20A, so as to image a transmission image of the banknote.

Furthermore, the imaging unit 20 has a magnetic sensor 20C for detecting magnetic distributions of a front and back faces of a banknote, and is configured to obtain a magnetic distribution of each banknote detected by the magnetic sensor 20C.

That is to say, the imaging unit 20 is configured to obtain, as a banknote image, a front face image and a back face image of a banknote having been transported by the transport unit 13, a transmission image of the banknote, and a magnetic distribution of the banknote.

The banknote information extracting unit 21 includes a denomination recognition unit 21A configured to recognize a denomination of a banknote having been transported by the transport unit 13, and a fitness recognition unit 21B configured to recognize whether a banknote having been transported by the transport unit 13 is a fit note or an unfit note.

Based on the banknote image of the banknote obtained from the imaging unit 20, the denomination recognition unit 21A is configured to recognize, for example, in a case of Japanese banknotes, a denomination (whether the banknote is a 10,000-yen banknote, 5,000-yen banknote, 2,000-yen banknote, or a 1,000-yen banknote), and a version (whether the banknote is a new version banknote or an old version banknote). In a case of foreign banknotes, the denomination recognition unit 21A is configured to recognize, in addition to a denomination, a version number (detail information of version) as a part of the denomination.

Based on the banknote image of the banknote obtained from the imaging unit 20, the fitness recognition unit 21B is configured to recognize fitness of the banknote, i.e., whether the banknote is a fit note corresponding to a banknote capable of being loaded into an ATM of a financial institute (hereinafter referred to simply as “ATM FIT note”), a fit note corresponding to a banknote capable of being used in a counter (hereinafter referred to simply as “TELLER FIT note”) or an unfit note corresponding to a banknote unsuitable for circulation (hereinafter referred to as “UNFIT note”). As compared with a TELLER FIT note, an ATM FIT note corresponds to a banknote that is less limp and less stained, and thus can smoothly pass through an inside mechanism of the ATM.

The handling-side control unit 23 includes a banknote information creating unit 23A configured to create banknote information of a banknote, a sorting condition setting unit 23B configured to set sorting conditions for the respective stackers 11.

The banknote information creating unit 23A is configured to create, as banknote information, a banknote image from the imaging unit 20, a denomination result of the denomination recognition unit 21A, a fitness result of the fitness recognition unit 21B, and a transaction ID for recognizing a transaction of the banknote.

The sorting condition setting unit 23B is configured to set sorting conditions, such as a denomination result and a fitness result, for the respective stackers 11. For example, a sorting condition in which a 10,000-yen banknote is stacked in the first stacker 11A is set, and a sorting condition in which a 5,000-yen banknote is stacked in the second stacker 11B. In this case, when a banknote having been transported by the transport unit 13 is a 10,000-yen banknote, the handling-side control unit 23 stacks the banknote in the first stacker 11A. On the other hand, when a banknote having been transported by the transport unit 13 is a 5,000-yen banknote, the handling-side control unit 23 stacks the banknote in the second stacker 11B.

In addition to the display unit 31, management-side operation unit 32 and database 33, the banknote management apparatus 3 includes a management-side interface 34 configured to serve as the communication interface between the banknote management apparatus 3 and the banknote handling apparatus 2, a management-side memory unit 35 configured to store therein various information, a printer interface 36 configured to serve as the communication interface between the banknote management apparatus 3 and the printer 4, and a management-side control unit 37 configured to control the whole banknote management apparatus 3.

The management-side operation unit 32 includes a search target input unit 32A provided for inputting the serial number of a target to be searched (i.e., a search target), and a serial number input unit 32B provided for allowing each serial number to be inputted, by hand, in place of a serial number recognition result which will be described later.

The search target input unit 32A is provided for inputting each serial number for searching the banknote detail information of the search target, from the data base 33, on the display screen of the display unit 31.

The management-side control unit 37 includes, a serial number identifying unit 37A configured to recognize characters of the serial number of each banknote and to obtain the serial number recognition result thereof, based on the banknote image included in the banknote information received from the banknote handling apparatus 2, a banknote detail information creating unit 37B configured to create the banknote detail information, based on the banknote information received from the banknote handling apparatus 2 and on the serial number recognition result obtained by the serial number identifying unit 37A (or inputted serial number), and a transaction information creating unit 37C configured to create the transaction information concerning the transaction of each banknote.

The serial number identifying unit 37A is configured to extract a predetermined serial number region from the banknote image, recognize the characters of the serial number from the so-extracted serial number region, and then obtain the serial number recognition result, based on the character recognition result. If the serial number recognition result cannot be obtained by the serial number identifying unit 37A, the management-side control unit 37 obtains the serial number inputted by a serial number input operation via the serial number input unit 32B.

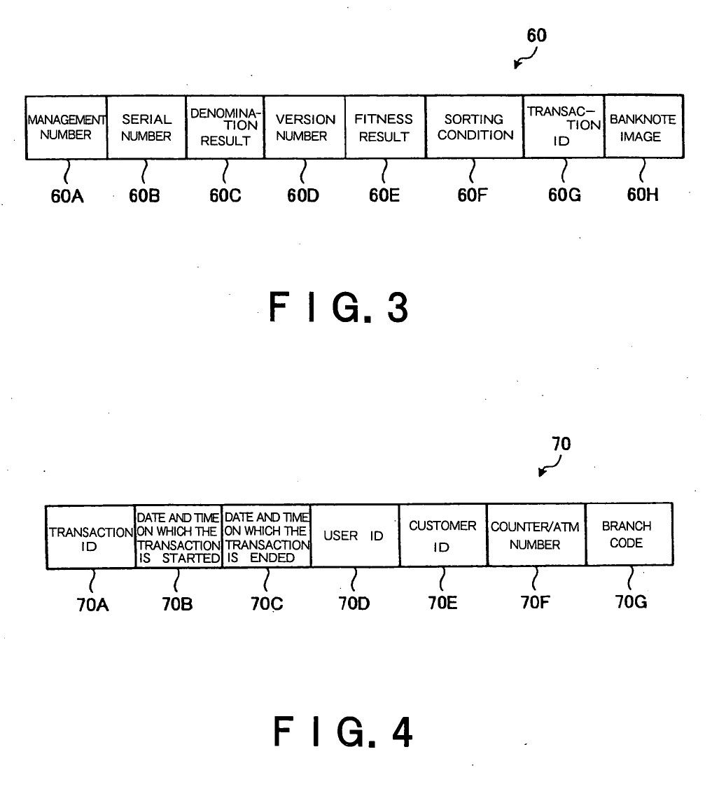

FIG. 3 is an explanatory view briefly showing a data structure of banknote detail information.

Banknote detail information 60 shown in FIG. 3 includes a management number 60A for recognizing a banknote, a serial number 60B of the banknote, a denomination result 60C of the banknote, a version number 60D of the banknote, a fitness result 60E of the banknote, a sorting condition 60F of the stacker 11 in which the banknote is sorted and stacked, a transaction ID 60G of the banknote, and a banknote image 60H of the banknote.

The transaction information creating unit 37C is configured to create transaction information as contents of transaction ID 60G of the banknote detail information created by the banknote detail information creating unit 37B.

FIG. 4 is an explanatory view briefly showing a data structure of transaction information.

The transaction information 70 shown in FIG. 4 includes the transaction ID 70A of a certain banknote, the date and time 70B on which the transaction of the banknote is started, the date and time 70C on which the transaction of the banknote is ended, the user ID 70D for verifying the person that made the transaction of the banknote, the customer ID 70E for verifying the customer of the transaction of the banknote, a counter or ATM number 70F for recognizing the counter and/or ATM at which the transaction of the banknote was made, and a branch code 70G for recognizing the branch at which the transaction of the banknote was carried out.

The database 33 includes a banknote detail information list data base 33A provided for the registration of the banknote detail information, and a transaction list database 33B provided for registration of the transaction information.

Further, the management-side control unit 37 includes a database control unit (hereinafter referred to as the “DB control unit”) 37D configured to control the registration at the database 33, and a search control unit 37E configured to search the banknote detail information on the serial number inputted via the search target input unit 32A, from the database 33.

The DB control unit 37D is configured to register, in the database 33, the banknote detail information and transaction information on each banknote stacked in each stacker 11.

The search control unit 37E is configured to search the banknote detail information and transaction information, respectively corresponding to the serial number of the search target inputted via the search target input unit 32A, from the database 33, and then control the display unit 31 to display the search result on the screen thereof. It is noted that the management-side control unit 37 can also control the printer 4 to print and output this search result.

In addition, when the banknote transition is made with some customer, and then the deposited banknotes are respectively detected via the banknote handling apparatus 2, the management-side control unit 37 obtains the serial number recognition result on each deposited banknote via the serial number identifying unit 37A, and controls the banknote detail information creating unit 37B to create the banknote detail information, based on the serial number recognition result and banknote information, and then controls the DB control unit 37D to register the banknote detail information in the database 33.

Further, the management-side control unit 37 includes the banknote transaction list information preparation unit 37F configured to search the banknote detail information and transaction information on all of the banknotes related to the banknote transaction, from the banknote detail information corresponding to the transaction ID related to the same banknote transaction, from the database 33, and then prepare the banknote transaction list information, based on the banknote detail information and transaction information on all of such transaction banknotes. In addition, the management-side control unit 37 includes the print and output control unit 37G configured to control the printer 4 to print and output the banknote transaction list, via the printer interface 36, based on the banknote transaction list information prepared by the banknote transaction list information preparation unit 37F.

The banknote transaction list information preparation unit 37F is configured to prepare the banknote transaction list information, as a list of the banknote detail information on all of the banknotes, for each banknote transaction. As used herein, the “banknote transaction of fifty 10000-yen banknotes” refers to the “transaction of fifty sheets of 10000-yen banknotes”.

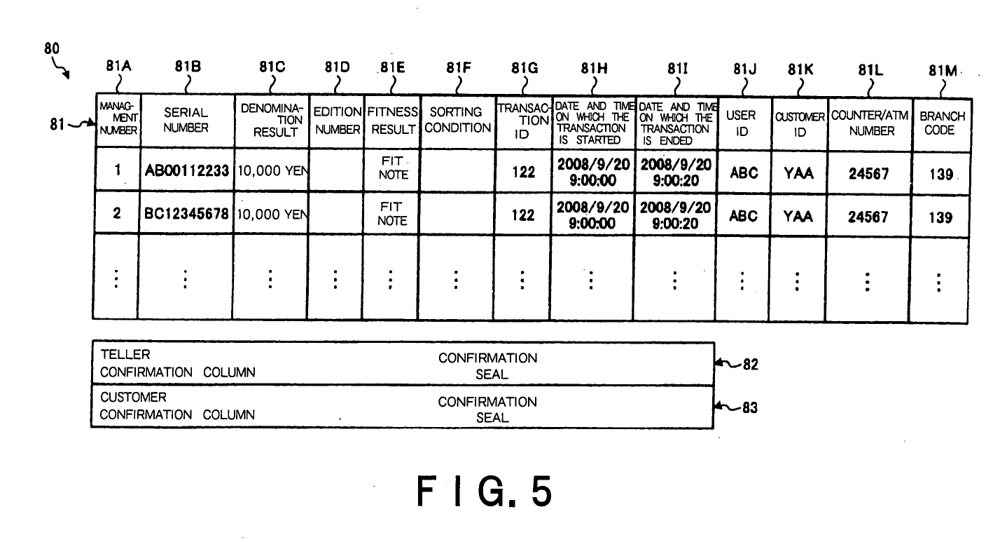

FIG. 5 is an explanatory view briefly showing the content of a printed banknote transaction list.

The banknote transaction list 80 shown in FIG. 5 includes a banknote transaction table 81, the teller confirmation entry column 82 and customer confirmation entry column (or blank) 83. More specifically, the banknote transaction table 81 includes the management number 81A, serial number 81B, denomination result 81C, version number 81D, fitness result 81E, sorting condition 81F, transaction ID 81G, date and time of the transaction start 81H, date and time of the transaction end 811, user ID 813, customer ID 81K, counter or ATM number 81L and branch code 81M, respectively related to a certain transaction banknote. The teller confirmation entry column 82 is provided for requesting a teller in charge of the transaction on the side of the related financial institution to sign and/or seal therein to verify the transaction contents. The customer confirmation entry column 83 is provided for requesting the customer to sign and seal therein to verify the transaction contents.

It is noted that, in the appended claims, the banknote management apparatus corresponds to the banknote management apparatus 3, the paper sheet corresponds to the banknote, the recognition information corresponds to the serial number, the recognition information identifying unit corresponds to the serial number identifying unit 37A, the recognition information list preparation unit corresponds to the banknote transaction list information preparation unit 37F, the recognition information list corresponds to the banknote transaction list 80, the recognition information list output unit corresponds to the print and output control unit 37G, the print and output unit corresponds to the print and output control unit 37G, and the confirmation column corresponds to the teller confirmation entry column 82 or customer confirmation entry column 83.

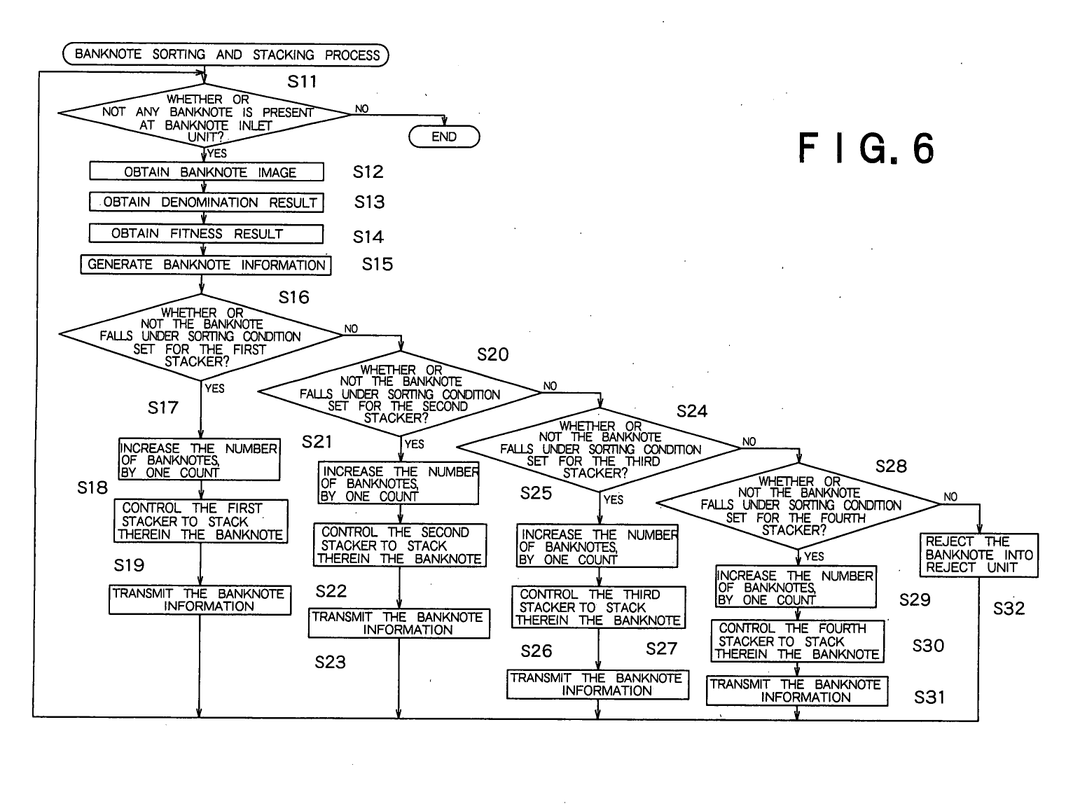

Now, the operation of the banknote management system 1 of the first embodiment will be described. FIG. 6 is a flow chart showing a process operation related to a banknote sorting and stacking process performed in a banknote handling apparatus 2.

The banknote sorting and stacking process shown in FIG. 6 is a process for sorting and stacking each banknote transported by the transport unit 13, depending on the sorting condition set for each stacker 11.

In FIG. 6, the handling-side control unit 23 judges whether or not the banknotes are present at the banknote inlet unit 12 (Step S11). If the banknotes are present at the banknote inlet unit 12, the transport unit 13 transports such banknotes, one by one.

If the banknotes are present at the banknote inlet unit 12 (i.e., “Yes” in the Step S11), the imaging unit 20 takes or obtains the image of each banknote present at the banknote inlet unit 12 (Step S12). In this case, the imaging unit 20 is configured to obtain each image of the front and back faces of each banknote, the transmitted light image of the banknote and magnetic distribution of the banknote, respectively as the banknote image.

When the banknote image of each banknote is obtained, the denomination recognition unit 21A in the banknote information extracting unit 21 recognizes the denomination of the banknote to obtain the denomination result (Step S13).

Further, when the denomination of each banknote is recognized, the fitness recognition unit 21B in the banknote information extracting unit 21 recognizes the fitness of the banknote to obtain the fitness result (Step S14).

Then, the banknote information creating unit 23A in the handling-side control unit 23 creates banknote information including the banknote image, denomination result, fitness result, and transaction ID of each banknote (Step S15).

The handling-side control unit 23 judges whether or not the banknote falls under the sorting condition set for the first stacker 11A, based on the generated banknote information (Step S16). At this point of time, the sorting condition setting unit 23B has already set the sorting condition, for each stacker 11, depending on a setting operation performed on the side of the banknote management apparatus 3.

If the banknote falls under the sorting condition set for the first stacker 11A (i.e., “Yes” in the Step S16), the handling-side control unit 23 increases the number of the banknotes, by one count, for the first stacker 11A (Step S17), and then operates the drive control unit 22 to control the first stacker 11A to stack therein this banknote (Step S18).

When the banknote is stacked in the first stacker 11A, the handling-side control unit 23 transmits the banknote information on this banknote to the banknote management apparatus 3 via the handling-side interface 19 (Step S19). Then, the handling-side control unit 23 returns the process to the Step S11 in order to detect the next banknote.

Meanwhile, if the banknote does not falls under the sorting condition set for the first stacker 11A (i.e., “No” in the Step S16), the handling-side control unit 23 judges whether or not this banknote falls under the sorting condition set for the second stacker 11B (Step S20).

If the banknote falls under the sorting condition set for the second stacker 11B (i.e., “Yes” in the Step S20), the handling-side control unit 23 increases the number of the banknotes, by one count, for the second stacker 11B (Step S21), and then operates the drive control unit 22 to control the second stacker 11B to stack therein this banknote (Step S22).

When the banknote is stacked in the second stacker 11B, the handling-side control unit 23 transmits the banknote information on this banknote to the banknote management apparatus 3 via the handling-side interface 19 (Step S23). Then, the handling-side control unit 23 returns the process to the Step S11 in order to detect the next banknote.

Meanwhile, if the banknote does not fall under the sorting condition set for the second stacker 11B (i.e., “No” in the Step S20), the handling-side control unit 23 judges whether or not this banknote falls under the sorting condition set for the third stacker 11C (Step S24).

If the banknote falls under the sorting condition set for the third stacker 11C (i.e., “Yes” in the Step S24), the handling-side control unit 23 increases the number of the banknotes, by one count, for the third stacker 11C (Step S25), and then operates the drive control unit 22 to control the third stacker 11C to stack therein this banknote (Step S26).

When the banknote is stacked in the third stacker 11C, the handling-side control unit 23 transmits the banknote information on this banknote to the banknote management apparatus 3 via the handling-side interface 19 (Step S27). Then, the handling-side control unit 23 returns the process to the Step S11 in order to detect the next banknote.

Meanwhile, if the banknote does not fall under the sorting condition set for the third stacker 11C (i.e., “No” in the Step S24), the handling-side control unit 23 judges whether or not this banknote falls under the sorting condition set for the fourth stacker 11D (Step S28).

If the banknote falls under the sorting condition set for the fourth stacker 11D (i.e., “Yes” in the Step S28), the handling-side control unit 23 increases the number of the banknotes, by one count, for the fourth stacker 11D (Step S29), and then operates the drive control unit 22 to control the fourth stacker 11D to stack therein this banknotes (Step S30).

When the banknote is stacked in the fourth stacker 11D, the handling-side control unit 23 transmits the banknote information on this banknote to the banknote management apparatus 3 via the handling-side interface 19 (Step S31). Then, the handling-side control unit 23 returns the process to the Step S11 in order to detect the next banknote.

Meanwhile, if the banknote does not fall under the sorting condition set for the fourth stacker 11D (i.e., “No” in the Step S28), the handling-side control unit 23 determines that the banknote does not fall under any sorting condition set for the stackers 11, then operates the drive control unit 22 to reject this banknote into the reject unit 14 (Step S32). Thereafter, the handling-side control unit 23 returns the process to the Step S11 in order to detect the next banknote.

If there is no banknote remaining in the banknote inlet unit 12 (i.e., “No” in the Step S11), the handling-side control unit 23 terminates the handling operation shown in FIG. 6.

Namely, in the above sorting and stacking process shown in FIG. 6, if the banknote transported by the transport unit 13 falls under a certain sorting condition, based on the sorting condition set for each stacker 11, this banknote is stacked in one stacker 11 for which the certain sorting condition is set or allotted. At the same time, the information (i.e., the banknote detail information) on this banknote stacked in the stacker 11 is transmitted to the banknote management apparatus 3 in order to register this information in the database 33 provided on the side of the banknote management apparatus 3. Thus, each banknote can be sorted and stacked, based on the sorting condition set for each stacker 11, as well as the banknote detail information on this banknote can be registered in the database 33 on the side of the banknote management apparatus 3.

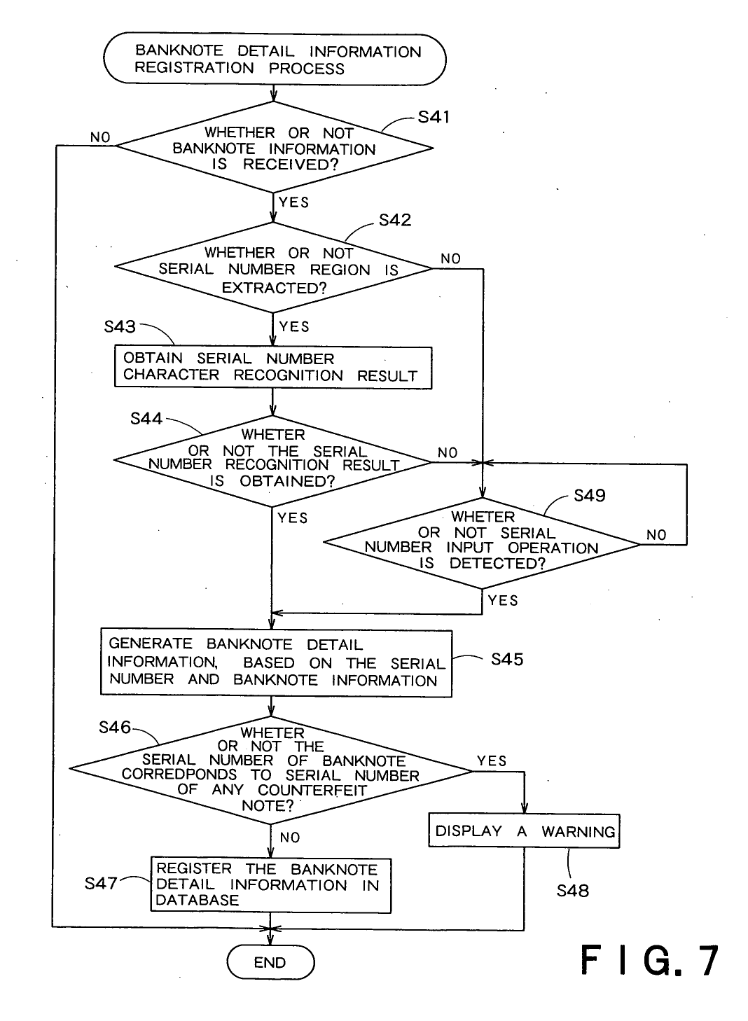

FIG. 7 is a flow chart showing a process operation related to a banknote detail information registration process performed in the banknote management apparatus 3.

In the banknote detail information registration process shown in FIG. 7, the serial number recognition result is obtained from the banknote image included in the banknote information sent from the banknote handling apparatus 2, while the banknote detail information created on the basis of the serial number recognition result (or inputted serial number) and banknote information is registered in the database 33.

In FIG. 7, the management-side control unit 37 judges whether or not the banknote information is received from the banknote handling apparatus 2, via the management-side interface 34 (Step S41).

If the banknote information is received (i.e., “Yes” in the Step S41), the serial number recognition unit 37A in the management-side control unit 37 further judges whether or not the predetermined serial number region of the banknote image in the banknote information is extracted (Step S42).

If the predetermined serial number region of the banknote image is extracted (i.e., “Yes” in the Step S42), the serial number recognition unit 37A recognizes each character of the serial number region in order to obtain the character recognition result (Step S43).

When the character recognition result of the serial number is obtained, the serial number recognition unit 37A judges whether or not the serial number recognition result is obtained on the basis of the character recognition result of this serial number (Step S44).

If the serial number recognition result is obtained by the serial number recognition unit 37A (i.e., “Yes” in the Step S44), the banknote detail information creating unit 37B in the management-side control unit 37 creates the banknote detail information, based on the obtained serial number recognition result and the banknote information (Step S45).

When the banknote detail information is generated, the management-side control unit 37 judges whether or not the serial number of the banknote of this banknote detail information corresponds to the serial number of any counterfeit note in a counterfeit note list (Step S46). Herein, the serial number of the counterfeit note list refers to any serial number listed in the serial number list obtained from a police organ or the like.

If the serial number recognition result of the banknote does not correspond to any serial number of the counterfeit note in the counterfeit note list (i.e., “No” in the Step S46), the DB control unit 37D in the management-side control unit 37 registers the banknote detail information of this banknote in the banknote detail information list database 33A inside the database 33 (Step S47), and then terminates the handling operation shown in FIG. 7.

Meanwhile, if the serial number recognition result of the banknote corresponds to some serial number of the counterfeit note in the counterfeit note list (i.e., “Yes” in the Step S46), the management-side control unit 37 controls the display unit 31 to display thereon a warning (Step S48), and then terminates the handling operation shown in FIG. 7. In this case, the user can recognize that the banknote is the counterfeit note, based on the warning displayed on the display unit 31.

If the predetermined serial number region of the banknote image is not extracted in the Step S42 (i.e., “No” in the Step S42), or if the serial number recognition result cannot be obtained in the Step S44 (i.e., “No” in the Step S44), the serial number recognition unit 37A judges whether or not any serial number input operation is detected (Step S49). Herein, the serial number input operation refers to the operation performed for inputting the serial number, by hand, via the serial number input unit 32B.

If the serial number input operation is detected (i.e., “Yes” in the Step S49), the serial number recognition unit 37A goes to the Step S45, in order to generate the banknote detail information, based on the inputted serial number and the banknote information.

Meanwhile, if the serial number input operation is not detected (i.e., “No” in the Step S49), the serial number recognition unit 37A returns to the Step S49, until the serial number input operation is detected.

In the banknote detail information registration process shown in FIG. 7, when the banknote information is received from the banknote handling apparatus 2, the serial number is recognized from the banknote image of this banknote information, and then the banknote detail information created on the basis of the recognized serial number as well as on the banknote information is registered in the database 33. Therefore, the banknote detail information on all of the banknotes can be managed for each transaction.

In this case, the search control unit 37E inside the management-side control unit 37 on the side of the banknote management apparatus 3 is configured to obtain s serial number of the search target via the search target input unit 32A, search, from the database 33, the banknote detail information corresponding to the serial number of the search target, among items of the banknote detail information, and then control the display unit 31 to display this search result on the screen thereof.

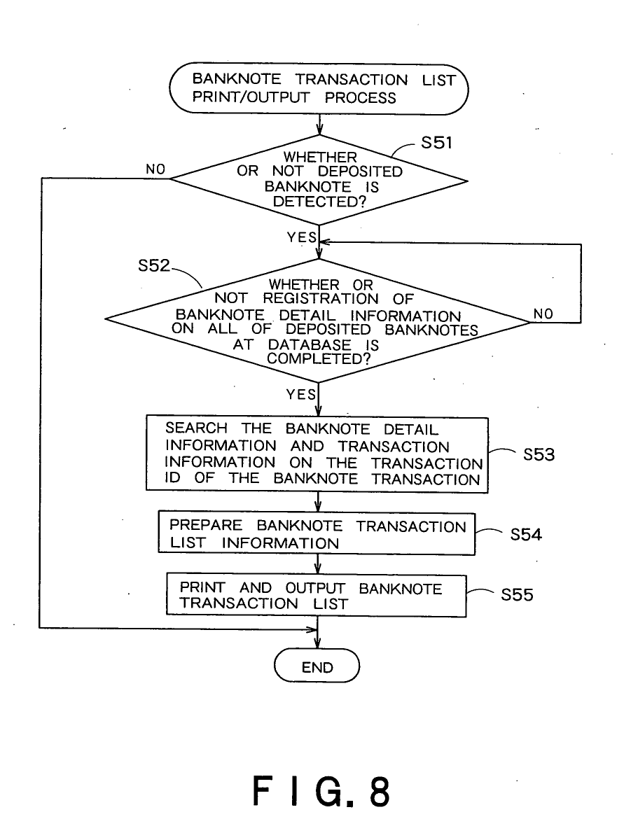

FIG. 8 is a flow chart showing a process operation related to a banknote transaction list print and output process performed in the banknote handling apparatus 3.

In the banknote transaction list print and output process shown in FIG. 8, when the deposited banknotes are deposited via the banknote handling apparatus 2 upon the depositing transaction of the banknotes, the banknote transaction list including the banknote detail information and transaction information, respectively related to this transaction and concerning all of the banknotes, is printed and outputted.

In FIG. 8, the banknote transaction list information preparation unit 37F inside the management-side control unit 37 of the banknote management apparatus 3 judges whether or not the deposited banknote deposited via the banknote handling apparatus 2 is detected (Step S51).

If the deposited banknote is detected (i.e., “Yes” in the Step S51), the banknote transaction list information preparation unit 37F further judges whether or not the registration of the banknote detail information on all of the deposited banknotes in the database 33 is completed through the banknote sorting and stacking process shown in FIG. 6 as well as through the banknote detail information registration process shown in FIG. 7 (Step S52).

If the registration of the banknote detail information on all of the deposited banknotes in the database 33 is completed (i.e., “Yes” in the Step S52), the banknote transaction list information preparation unit 37F searches, from the database 33, the banknote detail information and transaction information on the transaction ID of the banknote transaction (Step S53), and then prepares the banknote transaction list information, based on the searched banknote detail information and transaction information on the transaction ID (Step S54).

Subsequently, the print and output control unit 37G inside the management-side control unit 37 prepares the banknote transaction list 80 shown in FIG. 5, based on the banknote transaction list information, then controls the printer 4 to print and output the banknote transaction list 80 (Step S55), and thereafter terminates the handling operation shown in FIG. 8. In this case, the banknote transaction list 80 includes the banknote transaction table 81 including the banknote detail information and transaction information on all of the banknotes, as the transaction content, as well as includes the teller confirmation entry column 82 and customer confirmation entry column 83.

In the banknote transaction list print and output process shown in FIG. 8, the banknote transaction list information on the banknote transaction is prepared, on the basis of the banknote detail information and transaction information on the deposited banknotes, depending on the transaction of the deposited banknotes, and then the banknote transaction list 80 is prepared, on the basis of this banknote transaction list information, and thereafter this banknote transaction list 80 is printed and outputted. Therefore, the teller can present the transaction content of the banknotes to the customer.

In this case, the teller signs or seals in the teller confirmation entry column 82 in the printed and outputted banknote transaction list 80, after the deposited banknotes of the customer are respectively sorted and stacked by the banknote handling apparatus 2, upon the transaction of the deposited banknotes with the customer, and then presents this banknote transaction list 80 to the customer.

Thereafter, the customer checks whether or not the transaction content, i.e., the content of the banknote transaction list 80, corresponds to the deposited banknotes. Then, if verifying this transaction content, the customer signs or seals in the customer confirmation entry column 83 in the banknote transaction list 80, and then returns this transaction list 80 to the teller. In this case, the teller may hand a copy of the banknote transaction list 80 to the customer.

Thereafter, the teller manages this banknote transaction list 80 verified by the customer. Therefore, even if the counterfeit note is found in the deposited banknotes after the transaction, the customer of this banknote transaction can be identified. Then, by presenting, to this customer, the banknote transaction list 80 in which the transaction content was verified by the same customer, the fact that this customer has deposited the counterfeit note can be proved with ease.

Namely, in the above first embodiment, the banknote transaction list information is prepared, for each banknote transaction, based on the banknote detail information including the serial number of each transaction banknote as well as on the transaction information, and then the banknote transaction list 80 is printed and outputted on the basis of the so-prepared banknote transaction list information. Therefore, the teller and customer can confirm the transaction content, respectively, based on the printed banknote transaction list 80.

Further, in this first embodiment, the teller confirmation entry column 82 and customer confirmation entry column 83, for requesting the verification of the transaction content, are provided in the banknote transaction list 80, respectively. Therefore, each of the teller and customer can clearly indicate the intention to verify or not to verify the transaction content, by signing or sealing in the teller confirmation entry column 82 or customer confirmation entry column 83 in the banknote transaction list 80. Thus, the source of each transaction banknote can be clarified, thereby ensuring the reliability of the banknote transaction, as well as achieving the significantly stable banknote transaction.

While, in the above first embodiment, the banknote transaction list 80 concerning each deposited banknote is presented to the customer, in regard to the banknote transaction upon deposition of the banknotes to the financial institution from the customer, such presentation of the banknote transaction list 80 can also be applied to the banknote transaction upon dispensing the banknotes to the customer from the financial institution. In this case, the banknote transaction list information is prepared in the financial institution by the banknote transaction list information preparation unit 37F, based on the banknote detail information and transaction information on each banknote dispensed to the customer via the banknote handling apparatus 2, and then the banknote transaction list 80 concerning the dispensing transaction is printed and outputted by the print and output control unit 37G, based on the so-prepared banknote transaction list information.

As a result, the teller signs or seals in the teller confirmation entry column 82 in the banknote transaction list 80 concerning the dispensing transaction, in order to verify the transaction content of this dispensing transaction, and then presents this banknote transaction list 80 to the customer.

In addition, in order to verify the transaction content, the customer also signs or seals in the customer confirmation entry column 83 in the banknote transaction list 80, and then returns this banknote transaction list 80 to the teller.

Thereafter, the teller hands the copy of the banknote transaction list 80 to the customer and manages the banknote transaction list 80.

Thereafter, if the customer finds that some banknote dispensed from the financial institution is the counterfeit note, the fact that such a counterfeit note has been dispensed from this financial institution can be proved with ease, by presenting the banknote transaction list 80 to the financial institution.

Thus, the reliability of this banknote transaction between the customer and the financial institution can be ensured, thereby the significantly stable banknote transaction can be achieved.

In the above first embodiment, the banknote detail information and transaction information on each transaction banknote are printed and outputted into the banknote transaction table 81 in the banknote transaction list 80 concerning the banknote transaction. For instance, however, only the serial number of each transaction banknote may be printed and outputted into the banknote transaction table 81.

In addition, in the above first embodiment, the serial number recognition unit 37A is provided on the side of the banknote management apparatus 3. For instance, however, this serial number recognition unit 37A may be provided on the side of the banknote handling apparatus 2. In this case, the load or burden on the side of the banknote management apparatus 3 can be substantially reduced.

Further, in the above first embodiment, the banknote management system 1 has been described, by way of example, as one system for performing the banknote transaction, between the teller and the customer, at the counter or the like of the financial institution. For instance, however, the ATM of the financial institution can present the same effect as that of the banknote management system 1. Therefore, one example for employing this ATM will be described, hereinafter, as the second embodiment.

### Embodiment 2

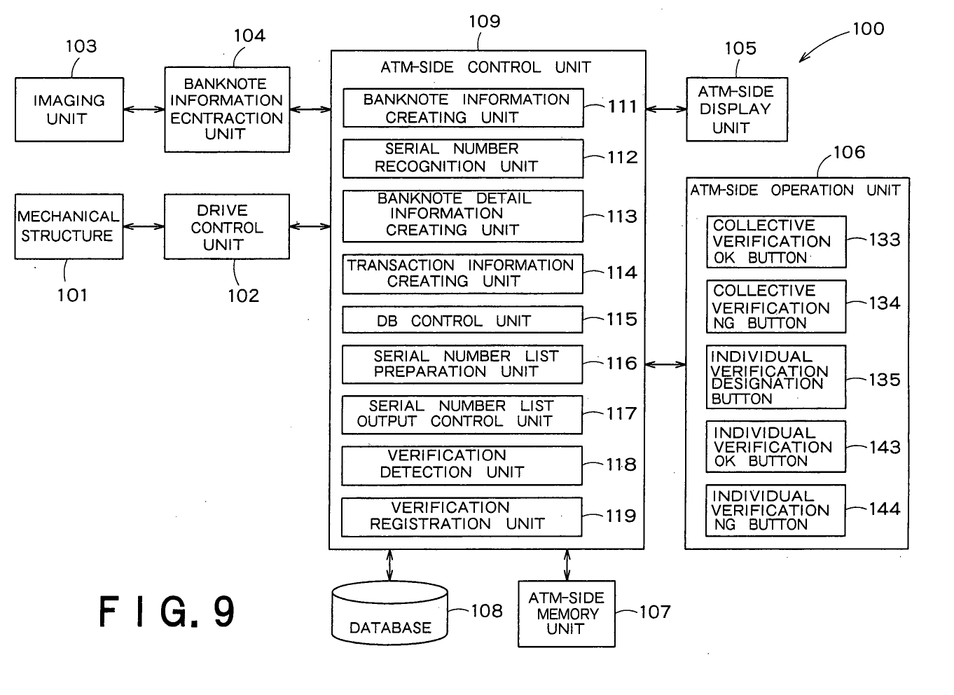

FIG. 9 is a block diagram schematically showing internal construction of the ATM related to a second embodiment of the present invention.

The ATM 100 shown in FIG. 9 includes a mechanical structure 101 including an input and output machine, sensors and the like, respectively provided for handling the banknotes, a drive control unit 102 configured to drive and control the mechanical structure 101, an imaging unit 103 configured to take the image of each banknote in the input and output machine inside the mechanical structure 101, and a banknote information extracting unit 104 configured to extract the banknote information from each banknote subjected to the imaging process provided by the imaging unit 103.

More specifically, the imaging unit 103 is configured to obtain the image of the front and back faces of each banknote, as well as obtain the transmitted light image, magnetic distribution and the like of this banknote, as the banknote image.

The banknote information extracting unit 104 is configured to obtain the denomination result and/or fitness result, based on each banknote image in the banknote information obtained by the imaging unit 103.

In addition, the ATM 100 includes an ATM-side display unit configured to display the various information on the screen thereof, an ATM-side operation unit 106 configured to allow various commands or the like to be inputted, an ATM-side memory unit 107 configured to store therein the various information, a database 108 configured to store and manage the banknote detail information and transaction information, respectively concerning various banknotes, and an ATM-side control unit 109 configured to control the entire system of the ATM 100.

The ATM-side control unit 109 includes a banknote information creating unit 111 configured to create the banknote information on each banknote, and the serial number recognition unit 112 configured to obtain the serial number recognition result on each banknote.

The banknote information creating unit 111 is configured to create the banknote information of each transaction banknote, based on the banknote image taken by the imaging unit 103, as well as on the denomination result and fitness result on the banknote, respectively extracted by the banknote information extracting unit 104, and the transaction ID provided for recognizing the banknote transaction.

The serial number recognition unit 112 is configured to extract the serial number region from each banknote image in the banknote information, and then recognize the characters of the serial number of each banknote from the extracted serial number region to obtain the character recognition result thereof, and thereafter obtain the serial number recognition result, based on the obtained character recognition result.

In addition to the above units respectively related to the creation of the banknote information, the ATM-side control unit 109 includes a banknote detail information creating unit 113 configured to create the banknote detail information, based on the serial number recognition result obtained by the serial number recognition unit 112, and a transaction information creating unit 114 configured to create the transaction information on the transaction of each banknote. In this case, the banknote detail information on each banknote includes the management number, serial number, denomination result, fitness result, sorting condition, transaction ID, banknote image and the like of the banknote, while the transaction information includes the transaction ID, date and time on which the transaction is started, date and time on which the transaction is ended, user ID, customer ID, counter or ATM number, branch code and the like.

Further, the ATM-side control unit 109 includes a DB control unit 115 configured to control the registration at the database 108, and the serial number list preparation unit 116 configured to search, from the database 108, the banknote detail information on each banknote of the banknote transaction, among the banknote detail information corresponding to the transaction ID related to the same banknote transaction, and then prepare the transaction serial number list information on all of the transaction banknotes, based on the serial number recognition result of the banknote detail information (or inputted serial number) related to all of the transaction banknotes of the same transaction.

Furthermore, the ATM-side control unit 109 includes: the serial number list output control unit 117 configured to control the ATM-side display unit 105 to display the transaction serial number list presenting screen, on the screen thereof, based on the transaction serial number list information prepared by the serial number list preparation unit 116; a verification detection unit 118 configured to detect a verification operation for verifying the transaction content on the transaction serial number list presenting screen; and a verification registration unit 119 configured to register the verification of the banknote transaction content in the database 108, while having this verification registration of the transaction content correspond to the banknote detail information on each transaction banknote, when the verification operation for verifying the transaction content is detected by the verification detection unit 118.

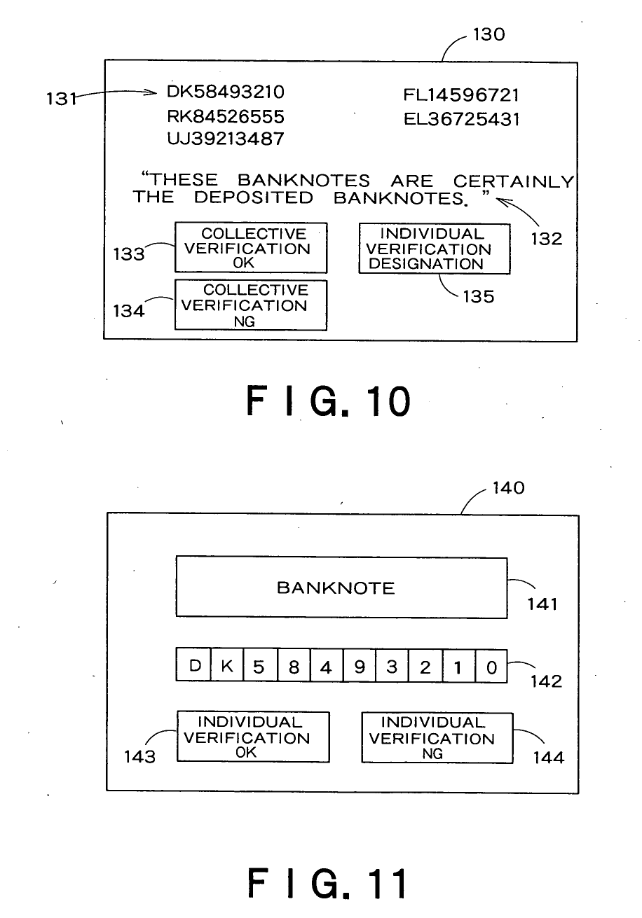

FIG. 10 is an explanatory view briefly showing a transaction serial number list presenting screen displayed on an ATM-side display unit 105 of the ATM 100, and FIG. 11 is an explanatory view briefly showing a transaction serial number individual verification screen displayed on the ATM-side display unit 105 of the ATM 100.

The serial number list output control unit 117 controls the ATM-side display unit 105 to display thereon the transaction serial number list presenting screen 130 shown in FIG. 10. This transaction serial number list presenting screen 130 includes a transaction serial number list 131 of the related transaction banknotes, a message 132 of “these banknotes are certainly the deposited banknotes”, a collective verification OK button 133 provided for verifying the transaction content, a collective verification NG button 134 provided for refusing or rejecting the verification of the transaction content, and an individual verification designation button 135 provided for designating individual verification. In this example shown in FIG. 10, it is noted that a total of five serial numbers of the banknotes, respectively related to the depositing transaction of the banknotes, are displayed on the screen.

When the button operation, by the customer, for the collective verification OK button 133 on the transaction serial number list presenting screen 130, is detected, the verification registration unit 119 registers the verification of the transaction content in the database 108, while having this verification registration of the transaction content correspond to the banknote detail information on each deposited banknote.

Meanwhile, when the button operation, by the customer, for the collective verification NG button 134 on the transaction serial number list presenting screen 130, is detected, the verification registration unit 119 determines that the verification of the transaction content of the deposited banknotes is rejected, and then performs a deposit cancelling process for all of the deposited banknotes.

When the deposit cancelling process for the deposited banknotes is performed, the ATM-side control unit 109 is configured to delete the banknote detail information and transaction information on all of the deposited banknotes from the database 108 via DB control unit 115, as well as to return all of the deposited banknotes to the customer, by driving a deposit and dispense machine provided in the mechanical structure 101, via the drive control unit 102.

Further, when the button operation, by the customer, for the individual verification designation button 135 on the transaction serial number list presenting screen 130, is detected, the serial number list output control unit 117 is configured to control the ATM-side display unit 105 to display, on its screen as shown in FIG. 11, the transaction serial number individual verification screen 140 provided for individually verifying the banknote depositing transaction, for each banknote. This transaction serial number individual verification screen 140 includes the banknote image 141 of the serial number related to the transaction banknote, the serial number 142 of this banknote, an individual verification OK button 143 provided for verifying the transaction content of the banknote, and an individual verification NG button 144 provided for rejecting the verification of the transaction content of the banknote.

When the button operation, by the customer, for the individual verification OK button 143 on the transaction serial number individual verification screen 140, is detected, the verification registration unit 119 determines that the transaction content on the banknote is verified, and then registers the verification of the transaction content in the database 108, while having this verification registration of the transaction content correspond to the banknote detail information of the same banknote. Further, when the button operation for the individual verification OK button 143 is detected, the serial number list output control unit 117 is configured to display the transaction serial number individual verification screen 140 concerning the next banknote in the transaction.

Meanwhile, when the button operation, by the customer, for the individual verification NG button 144 on the transaction serial number individual verification screen 140, is detected, the verification registration unit 119 determines that the verification of the transaction content on the banknote is rejected, and then performs the deposit cancelling process for this banknote.

When the deposited cancelling process for the banknote is performed, the ATM-side control unit 109 is configured to delete the banknote detail information and transaction information on this banknote from the database 108 via DB control unit 115, as well as to return the banknote to the customer, by driving the deposit and dispense machine provided inside the mechanical structure 101, via the drive control unit 102.

Further, when the button operation for the individual verification NG button 144 is detected, the serial number list output control unit 117 is configured to display the transaction serial number individual verification screen 140 concerning the next banknote in the transaction.

It is noted that, in the appended claims, the banknote management apparatus corresponds to the ATM 100, the paper sheet corresponds to the banknote, the recognition information corresponds to the serial number, the recognition information identifying unit corresponds to the serial number recognition unit 112, the recognition information list preparation unit corresponds to the serial number list preparation unit 116, the recognition information list corresponds to each of the transaction serial number list presenting screen 130 and transaction serial number individual verification screen 140, the recognition information list output unit and verification request unit respectively corresponds to the serial number list output control unit 117.

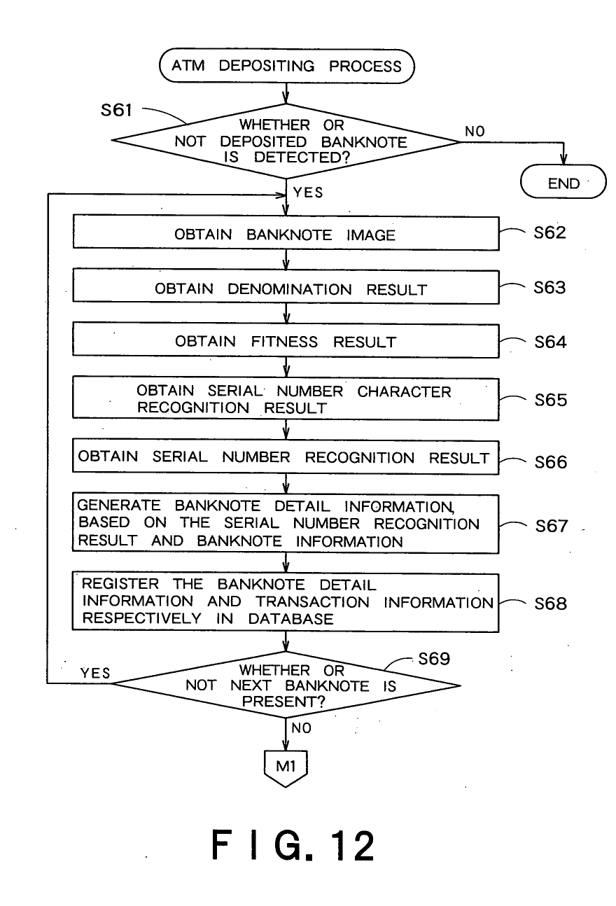

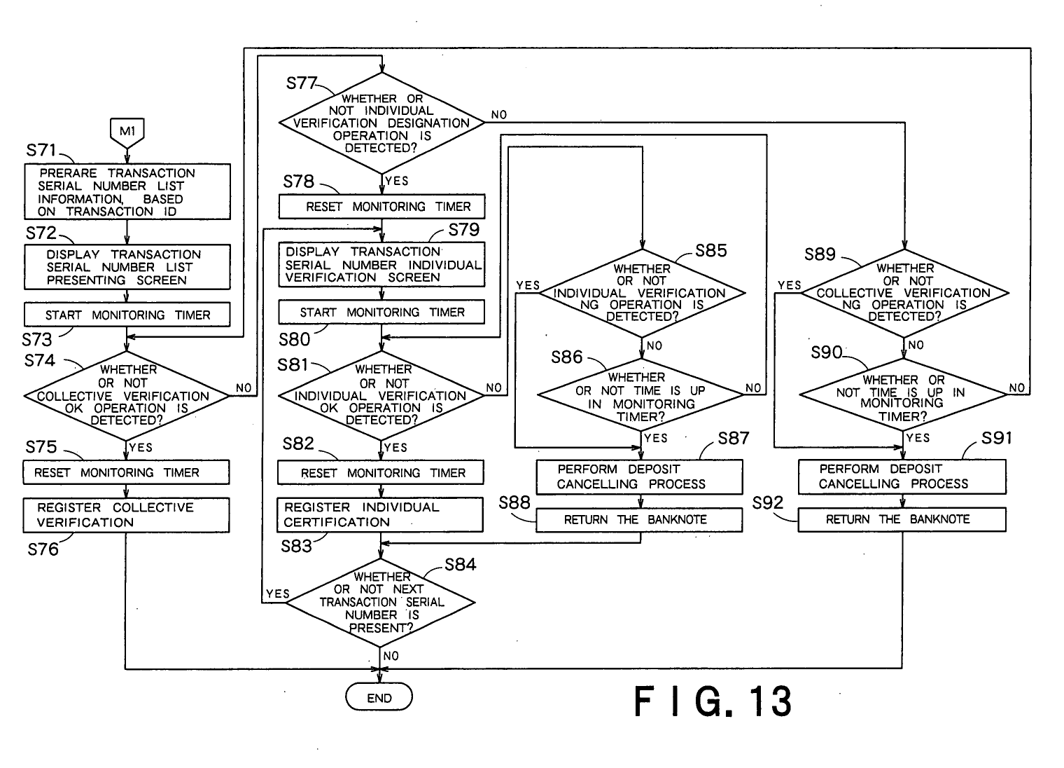

Now, the operation of the ATM 100 related to the second embodiment will be described. FIGS. 12, 13 are respectively flow charts showing the process operation related to the ATM depositing process performed in the ATM 100.

In the case of receiving the deposited banknotes in the ATM depositing process shown in FIGS. 12, 13, the transaction serial number list presenting screen 130 for presenting each serial number of all of the transaction banknotes related to the banknote transaction is first displayed on the screen, in order to request the customer to verify the transaction content of the deposited banknotes.

The ATM-side control unit 109 in the ATM 100 shown in FIG. 12 judges whether or not the deposited banknote is detected (Step S61). In this case, the ATM 100 detects the reception of each banknote deposited from the customer (or user), after an IC card, such as a cash card or the like, is inserted for the verification of the customer (or user) and then the customer (or user) is verified by this IC card.

When the deposited banknote is detected (i.e., “Yes” in the Step S61) and then the image of the deposited banknote is obtained by the imaging unit 103 (Step S62), the banknote information extracting unit 104 obtains the denomination result from this banknote image (Step S63), and also obtains the fitness result from the same banknote image (Step S64). In this case, the banknote information creating unit 111 is configured to create the banknote information, based on the so-obtained banknote image, denomination result and fitness result, as well as on the transaction ID.

The serial number recognition unit 112 extracts the serial number region of the banknote image in the banknote information, and then obtains the character recognition result of the serial number from the extracted serial number region (Step S65).

When obtaining the character recognition result of the serial number, the serial number recognition unit 112 further obtains the serial number recognition result, based on the obtained character recognition result (Step S66).

The banknote detail information creating unit 113 creates the banknote detail information, based on the serial number recognition result obtained by the serial number recognition unit 112 as well as on the banknote information (Step S67). In this case, the transaction information creating unit 114 is configured to create the transaction information on each banknote.

Thereafter, the DB control unit 115 has the banknote detail information generated by the banknote detail information creating unit 113 and the transaction information created by the transaction information creating unit 114 registered respectively in the database 108 (Step S68).

Then, the ATM-side control unit 109 judges whether or not the next banknote, which is not yet registered about the banknote detail information and transaction information thereof, is present, among the transaction banknotes in the depositing transaction, respectively detected at the Step S61 (Step S69).

If there is an unregistered next banknote (i.e., “Yes” in the Step S69), the ATM-side control unit 109 returns to the Step S62 in order to obtain the banknote image of this banknote.

Meanwhile, if there is no unregistered next banknote (i.e., “No” in the Step S69), the ATM-side control unit 109 goes to M1 shown in FIG. 13.

Further, if the deposited banknote is not detected in the Step S61 (i.e., “No” in the Step S61), the ATM-side control unit 109 terminates the handling operation shown in FIG. 12.

Then, in the stage designated by M1 shown in FIG. 13, the serial number list preparation unit 116 searches the banknote detail information on the transaction ID of the banknote transaction from the database 108, and then prepares, based on this search result, the transaction serial number list information, in which the serial numbers of all of the banknotes related to the same banknote transaction are listed (Step S71).

The serial number list output control unit 117 controls the ATM-side display unit 105 to display, on its screen, the transaction serial number list presenting screen 130 shown in FIG. 10, based on the transaction serial number list information prepared by the serial number list preparation unit 116 (Step S72). In this case, the customer can check the transaction content including the serial numbers of all of the banknotes related to this banknote depositing transaction, based on the screen content of the transaction serial number list presenting screen 130.

The verification detection unit 118 starts a clock operation of a monitoring timer for monitoring the button operation on the transaction serial number list presenting screen 130 (Step S73), and judges whether or not the button operation, by the customer, for the collective verification OK button 133 on the transaction serial number list presenting screen 130, is detected (Step S74).

If the button operation for the collective verification OK button 133 is detected (i.e., “Yes” in the Step S74), the verification registration unit 119 resets the clock operation of the monitoring timer (Step S75), and determines that the transaction content on all of the banknotes related to the banknote depositing transaction is verified. Then, the verification registration unit 119 registers this verification of the transaction content collectively in the database 108, while having this verification registration correspond to the banknote detail information on all of the deposited banknotes (Step S76). Thereafter, the verification registration unit 119 terminates the handling operation shown in FIG. 13.

Meanwhile, if the button operation for the collective verification OK button 133 is not detected at the Step S74 (i.e., “No” in the Step S74), the verification detection unit 118 judges whether or not the button operation for the individual verification designation button 135 on the transaction serial number list presenting screen 130 is detected (Step S77).

If the button operation for the individual verification designation button 135 is detected (i.e., “Yes” in the Step S77), the serial number list output control unit 117 resets the clock operation of the monitoring timer (Step S78), and displays, on its screen as shown in FIG. 11, the transaction serial number individual verification screen 140 provided for displaying thereon the serial numbers of the deposited banknotes, for each banknote, (Step S79). In this case, the user can recognize the transaction content, for each banknote, based on the screen content of this transaction serial number individual verification screen 140.

The verification detection unit 118 starts the clock operation of the monitoring timer for monitoring the button operation on the transaction serial number individual verification screen 140 (Step S80), and judges whether or not the button operation for the individual verification OK button 143 on the transaction serial number individual verification screen 140 is detected (Step S81).

If the button operation for the individual verification OK button 143 is detected (i.e., “Yes” in the Step S81), the verification registration unit 119 resets the clock operation of the monitoring timer (Step S82), and determines that the transaction content on the banknote is verified. Then, the verification registration unit 119 registers this verification of the transaction content individually in the database 108, while having this verification registration correspond to the banknote detail information on the banknote (Step S83). Thereafter, the verification registration unit 119 judges whether or not the next transaction serial number, for which the presence or absence of verification is not yet designated, is present, among the transaction banknotes (Step S84).

If the next transaction serial number is not present (i.e., “No” in the Step S84), the verification registration unit 119 determines that the designation for the presence or absence of the verification of all of the transaction content is completed, and then terminates the handling operation shown in FIG. 13.

Meanwhile, if the next transaction serial number is present (i.e., “Yes” in the Step S84), the verification registration unit 119 returns to the Step S79, in order to display, on the screen, the transaction serial number individual verification screen 140 related to the next transaction serial number.

Further, if the button operation for the individual verification OK button 143 on the transaction serial number individual verification screen 140 is not detected (i.e., “No” in the Step S81), the verification detection unit 118 judges whether or not the button operation for the individual verification NG button 144 on the transaction serial number individual verification screen 140 is detected (Step S85)

If the button operation for the individual verification NG button 144 is not detected (i.e., “No” in the Step S85), the verification detection unit 118 judges whether or not the time is up in the monitoring timer (Step S86).

If the time is up in the monitoring timer (i.e., “Yes” in the Step S86), the verification registration unit 119 determines that the verification of the transaction content of the banknote is rejected, and performs the deposit cancelling process for the banknote on the transaction serial number individual verification screen 140 (Step S87).

When the deposit cancelling process for the banknote is performed, the ATM-side control unit 109 returns the banknote to the customer via the input and output machine inside the mechanical structure 101 (Step S88), and then goes to the Step S84, in order to judge whether or not the next transaction serial number is present.

Meanwhile, if the button operation for the individual verification NG button 144 is detected in the Step S85 (i.e., “Yes” in the Step S85), the verification registration unit 119 determines that the verification of the transaction content of the banknote is rejected, and then goes to the Step 87, in order to perform the deposit cancelling process for the banknote on the transaction serial number individual verification screen 140.

Further, if the button operation for the individual verification designation button 135 on the transaction serial number list presenting screen 130 is not detected (i.e., “No” in the Step S77), the verification detection unit 118 judges whether or not the button operation for the collective verification NG button 134 on the transaction serial number list presenting screen 130 is detected (Step S89).

If the button operation for the collective verification NG button 134 is not detected (i.e., “No” in the Step S89), the verification detection unit 118 further judges whether or not the time is up in the monitoring timer that started its clock operation at the Step S73 (Step S90).

If the time is up in the monitoring timer (i.e., “Yes” in the Step S90), the verification registration unit 119 determines that the verification of the transaction content of all of the transaction banknotes related to the depositing transaction is rejected, and then performs the deposit cancelling process for all of such transaction banknotes (Step S91).

When the deposit cancelling process for all of the transaction banknotes is performed, the ATM-side control unit 109 returns all of the banknotes to the customer (Step S92), and then terminates the handling operation shown in FIG. 13. In this case, the ATM-side control unit 109 serves to delete all banknote detail information and all transaction information, respectively related to such transaction banknotes, from the database 108.

If the button operation for the collective verification NG button 134 is detected in the Step S89 (i.e., “Yes” in the Step 89), the verification detection unit 118 determines that the verification of the transaction content of all of the transaction banknotes related to the depositing transaction is rejected, and then goes to the Step S91, in order to perform the deposit cancelling process for all of the transaction banknotes.

Meanwhile, if the time is not yet up in the monitoring timer (i.e., “No” in the Step S90), the verification detection unit 118 goes to the Step S74, in order to judge whether or not the button operation for the collective verification OK button 133 on the transaction serial number list presenting screen 130 is detected.

In the above ATM depositing process shown in FIGS. 12 and 13, the transaction serial number list information is prepared, based on the serial numbers of all of the deposited banknotes related to the depositing transaction, upon the same depositing transaction, and then the transaction serial number list presenting screen 130 is displayed on the screen of the ATM-side display unit 105, based on the prepared transaction serial number list information. Therefore, the customer can recognize the transaction content, based on the serial number list 131 on the transaction serial number list presenting screen 130.

Further, in this ATM depositing process, when the button operation for the collective verification OK button 133 on the transaction serial number list presenting screen 130 is detected, the transaction content related to all of the deposited banknotes is determined to be verified, and then such verification is collectively registered in the database 108, while this verification registration corresponds to the banknote detail information of all of the deposited banknotes. Thus, by the button operation for the collective verification OK button 133, the customer can collectively verify the transaction content related to all of the deposited banknotes.

Further, in the above ATM depositing process, when the button operation for the collective verification NG button 134 on the transaction serial number list presenting screen 130 is detected, the verification of the transaction content related to all of the deposited banknotes is determined to be rejected, and then the deposit cancelling process for all of the deposited banknotes is performed, while all of such deposited banknotes are returned to the customer. Therefore, by the button operation for the collective verification NG button 134, the customer can reject collectively the verification of the transaction content related to all of the deposited banknotes.

Additionally, in the above ATM depositing process, when the button operation for the individual verification designation button 135 on the transaction serial number list presenting screen 130 is detected, the transaction serial number individual verification screen 140 provided for verifying the deposited banknotes related to the transaction, individually, for each banknote, is displayed on the screen of the ATM-side display unit 105. As such, the customer can recognize the transaction content, for each deposited banknote, based on each serial number and each banknote image on the transaction serial number individual verification screen 140.

Further, in the above ATM depositing process, when the button operation for the individual verification OK button 143 on the transaction serial number individual verification screen 140 is detected, the transaction content of the deposited banknote is determined to be verified, and then the verification of this transaction content is individually registered in the database 108, while this verification registration corresponds to the banknote detail information. Therefore, by the button operation for the individual verification OK button 143, the customer can verify the transaction content of each deposited banknote.

Besides, in the above ATM depositing process, when the individual verification NG button 144 on the transaction serial number individual verification screen 140 is detected, the verification of the transaction content of the deposited banknote is determined to be rejected, and then the deposit cancelling process for the deposited banknote is performed, while this deposited banknotes are returned to the customer. Therefore, by the button operation for the individual verification NG button 134, the customer can reject the verification of the transaction content related to the deposited banknote.

Thus, for instance, by managing the verification registration registered in the database 108, in regard to the transaction content related to each of the banknote detail information, for each deposited banknote verified by the customer, the financial institution can identify the customer that deposited the counterfeit note and present, to this customer, the transaction content subjected to the verification registration, even though this deposited banknote is determined later to be the counterfeit note. As such, the fact that this customer has deposited the counterfeit note can be proved with ease.

Namely, in the above second embodiment, the serial number of the transaction banknote is recognized, for each banknote transaction, and then the transaction serial number list information is prepared, based on the recognized serial number of each transaction banknote. Thereafter, the transaction serial number list presenting screen 130 is displayed on the screen of the ATM-side display unit 105, based on the prepared transaction serial number list information. Therefore, the customer can recognize the transaction content, based on the transaction serial number list 131 on the transaction serial number list presenting screen 130.

Further, in the above second embodiment, the button operation (or verification operation) for the collective verification OK button 133 or collective verification NG button 134 on the transaction serial number list presenting screen 130 is required. Therefore, the customer can clearly indicate the intention to verify or not to verify the transaction content, for each banknote transaction, by the button operation for the collective verification OK button 133 or collective verification NG button 134.

Additionally, in the above second embodiment, the button operation (or verification operation) for the individual verification OK button 143 or individual verification NG button 144 on the transaction serial number individual verification screen 140 is required. As such, the customer can clearly indicate the intention to verify or not to verify the transaction content, for each banknote, by the button operation for the individual verification OK button 143 or individual verification NG button 144.

Further, the financial institution can clarify the source of the deposited banknote, in response to the verification operation for the transaction content on the screen on the side of the customer, thereby confirming the intention of the customer concerning the transaction content. Thus, the reliability of the banknote transaction can be ensured, while the significantly stable banknote transaction can be achieved.

By the way, in the above second embodiment, the transaction serial number list presenting screen 130 related to the deposited banknotes is presented to the customer, upon the banknote transaction for the banknotes deposited to the ATM 100 from the customer. However, upon the banknote transaction for the banknotes dispensed to the customer from the ATM, a bill of dispensed money, in which the serial numbers of the banknotes to be dispensed are respectively recorded, may be printed and outputted, and then presented to the customer.

In this case, even though the banknote dispensed from the ATM 100 upon the dispensing transaction is determined later to be the counterfeit note, the customer can readily prove the fact that this banknote was dispensed from the ATM 100 of the financial institution, by presenting the bill of dispensed money to this financial institution.

As such, the reliability of the banknote transaction between the customer and the financial institution can be ensured, thereby contributing to the achievement of the significantly stable banknote transaction.

By the way, in the above second embodiment, when the button operation for the individual verification designation button 135 on the transaction serial number list presenting screen 130 is detected, the transaction serial number individual verification screen 140 is displayed, on the screen, for allowing the transaction content to be verified, or otherwise for allowing such verification to be rejected, for each transaction banknote, in response to the button operation for the individual verification OK button 143 or individual verification NG button 144 on the transaction serial number individual verification screen 140. However, any given transaction banknote may be selected, at random, from all of the transaction banknotes in the banknote transaction, such that the transaction content related to all of the transaction banknotes in the banknote transaction can be collectively verified, or otherwise such verification can be collectively rejected, in response to the button operation for the individual verification OK button 143 or individual verification NG button 144 on the transaction serial number individual verification screen 140 related to the transaction banknote selected at random. In this case, the operation load or burden on the side of the customer upon verifying the transaction content can be substantially reduced.

Additionally, in the above second embodiment, the IC card, such as the cash card or the like, is used for verifying the user, upon the banknote transaction made with the customer by using the ATM 100. However, this IC card may also be used for the registration, therein, of each serial number of the deposited banknotes or dispensed banknotes related to the transaction content. With this use of the IC card, the need for performing any other special operation that would be otherwise provided for the verification of the transaction content can be eliminated, irrespectively of whether or not the transaction serial number list presenting screen 130 is displayed on the screen.

In this case, if the deposited banknote is determined as the counterfeit note after the banknote transaction, the financial institution identifies the customer related to this deposited banknote, based on the banknote detail information and transaction information respectively concerning the deposited banknote registered in the database 108, and then requests the customer to present the IC card. Thereafter, the financial institution compares the serial number of the deposited banknote registered in the IC card with the serial number related to the counterfeit note. As a result, if the serial number of the deposited banknote registered in the IC card corresponds to the serial number related to the counterfeit note, the financial institution presents the comparison result to the customer, thereby readily proving that the customer deposited the counterfeit note.

Meanwhile, if the dispensed banknote is determined as the counterfeit note, the customer presents the IC card to the financial institution, and compares the serial number related to the dispensed banknote registered in the IC card with the serial number in the banknote detail information related to the dispensed banknote registered in the database 108. Thus, based on this comparison result, the customer can readily prove that the dispensed banknote was dispensed from the financial institution.

Further, while, in the above first and second embodiments, the banknote transaction has been described by way of example, any other suitable paper sheets, such as the checks, bills or drafts, vouchers or the like, can be applied to this invention. Of course, also in such an application, the paper sheet management apparatus related to this invention can present the same effect as in the case of managing the banknotes.

As stated above, while several embodiments have been shown and described, it will be understood that there is no intent to limit this invention by such disclosure. Namely, it should be appreciated that various modifications and alterations can be made to such embodiments, without departing from the scope and sprit of this invention as defined by the appended claims. Further, it should be understood that the effect of the above embodiments is not in any way limited to that disclosed herein.

Further, a part or all of such operations as described to be automatically performed in the above embodiments may be performed by hand. Contrary, a part or all of such operations as described to be manually performed in the above embodiments may be performed automatically. In addition, the procedure of each handling operation, procedure of each control operation, specific names, information including various data and/or parameters, as respectively described in the above embodiments, may be suitably altered, unless defined otherwise.

Furthermore, each component as depicted in the drawing or drawings is intended to explain a certain function thereof, schematically, by way of example. Namely, it should be understood that such a component is not intended in any way to specify any physically and/or structurally limited construction thereof.

Furthermore, a given part or all of each function and/or operation performed by each corresponding apparatus, unit or section may be executed by a CPU (Central Processing Unit) (or microcomputer, such as an MPU (Micro Processing Unit), MCU (Micro Controller Unit) or the like), or on a program analyzed and operated by the CPU (or by the microcomputer, such as the MPU, MCU or the like), or otherwise on a hardware including a wired logic.

1. A paper sheet management apparatus comprising:
a recognition information identifying unit configured to identify recognition information on each paper sheet, for each predetermined transaction;
a recognition information list preparation unit configured to prepare a recognition information list related to the recognition information identified by the recognition information identifying unit, for each predetermined transaction; and
a recognition information list output unit configured to output the recognition information list prepared by the recognition information list preparation unit.

2. The paper sheet management apparatus according to claim 1,
wherein the recognition information list output unit is provided as a print and output unit configured to print and output the recognition information list prepared by the recognition information list preparation unit.

3. The paper sheet management apparatus according to claim 2,
wherein the recognition information list includes a verification column provided for requesting verification of the transaction content related to the recognition information list.

4. The paper sheet management apparatus according to claim 1,
wherein the recognition information list output unit is provided as a display and output unit configured to display and output the recognition information list prepared by the recognition information list preparation unit.

5. The paper sheet management apparatus according to claim 4, further comprising a verification request unit configured to request the verification of the transaction content related to the recognition information, for each of the recognition information in the recognition information list, upon the display and output of the recognition information list by the display and output unit.

6. The paper sheet management apparatus according to claim 4, further comprising a verification request unit configured to request collective verification of the transaction content related to the recognition information list, for each predetermined transaction, upon the display and output of the recognition information list by the display and output unit.

7. The paper sheet management apparatus according to claim 4, further comprising a verification request unit configured to request the verification of the transaction content related to any given recognition information among the recognition information on a plurality of paper sheets in the predetermined transaction, as the collective verification of the transaction content related to the recognition information list, upon the display and output of the recognition information list by the display and output unit.

8. The paper sheet management apparatus according to claim 5,
wherein the verification of the transaction content is performed, in response to an operation of a verification button.

9. The paper sheet management apparatus according to claim 6,
wherein the verification of the transaction content is performed in response to an operation of a verification button.

10. A paper sheet management method, comprising:
identifying recognition information on each paper sheet for each predetermined transaction;
preparing a recognition information list related to the recognition information which is identified for each predetermined transaction in the identification of the recognition information; and
outputting the recognition information list prepared in the preparation of the recognition information list.

11. A paper sheet management program provided for operating a computer to execute a handling program, the handling program comprising:
a recognition information identifying process for identifying recognition information on each paper sheet, for each predetermined transaction;
a recognition information list preparation process for preparing a recognition information list related to the recognition information identified in the recognition information identifying process, for each predetermined transaction; and
a recognition information list output process for outputting the recognition information list prepared in the recognition information list preparation process.

12. The paper sheet management apparatus according to claim 7,
wherein the verification of the transaction content is performed, in response to an operation of a verification button.

13. The paper sheet management apparatus according to claim 1, further comprising a user verification unit configured to verify a user by using a recording medium containing data for verification, when the recording medium is detected upon starting the predetermined transaction,
wherein the recognition information list output unit is provided as a registration and output unit configured to register and output the recognition information list prepared by the recognition information list preparation unit to the recording medium.
